(19) United States
(12) Patent Application Publication
(10) Pub. No.: US 2006/0211433 A1
(43) Pub. Date: Sep. 21, 2006

(54) Portable electronic apparatus and non-carry processing program storage medium

(75) Inventors: Eriko Ito, Sapporo (JP); Atsushi Itoh, Sapporo (JP); Masahiro Harima, Sapporo (JP); Osamu Yamauchi, Sapporo (JP); Hiroshi Fushikida, Sapporo (JP); Tetsuya Murata, Sapporo (JP); Hidenori Konno, Sapporo (JP); Kousuke Taneda, Sapporo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/188,621

(22) Filed: Jul. 26, 2005

(30) Foreign Application Priority Data
Mar. 17, 2005 (JP) 2005-77109

(51) Int. Cl. H04Q 7/20

(52) U.S. Cl. 455/456.6

(57) ABSTRACT

The present invention provides a portable electronic apparatus such as a portable telephone, which improves safety in a situation where the apparatus is left behind. The portable electronic apparatus includes: a storing section that stores a pair of designated time and designated position; a time obtaining section that obtains a current time; a position obtaining section that obtains a current position; a determination section that determines whether there is a match or a mismatch between the current position at the current time reaching the designated time and the designated position that is paired with the designated time; and a mismatch processing section that performs mismatch processing in response to a mismatch determined by the determination section as a determination result.

### BACKGROUND OF THE INVENTION

1. Field of the Invention

The present invention relates to a portable electronic apparatus such as a portable telephone for example, which is intended to be carried by a user, and to a program storage medium for storing a program executed in such a portable electronic apparatus.

2. Description of the Related Art

Devices such as portable telephones and PDAs (Personal Data Assistant) are usually carried by users all day or placed very close to the users and thus the devices have been downsized and made lightweight to improve the portability.

However, the users sometimes unintentionally leave the devices at home when they go out or leave them behind in some places where they have visited.

In such situations, there should be no problem if users immediately realize the fact that they have left behind the device such as a portable telephone and the place where they have left behind the device is such a safe place that there is no need to worry about stealing. However, if users do not realize the fact that the device has been left behind, the device might be abused.

As one conventional technique, Japanese Patent Application Publication No. 2002-111858 discloses a technique for preventing fraud by sending a mail including a specific keyword and a password to a portable telephone to lock its function.

However, this technique is effective only when the user realizes the loss, which is completely unuseful when he/she does not realize it.

As another conventional technique, Japanese Patent Application Publication No. 2004-185329 discloses a system including a portable terminal in which a Global Positioning System (GPS)-compliant receiver is incorporated. In this system, the portable terminal is carried by a child, which periodically transmits information about the current location of the terminal to a management terminal that stores the association relation between scheduled locations and time periods. If the location of the received information does not match the scheduled location associated with the time period, the management terminal informs the parents of such a mismatch through their receiver terminal such as a personal computer.

However, this is not a technique adapted to solve the problems related to left-behind or lost terminals and it works on condition that children properly carry their portable terminals.

### SUMMARY OF THE INVENTION

The present invention has been made in view of the above circumstances and provides a portable electronic apparatus that improves safety when the apparatus is left behind and a program storage medium that stores a program for realizing such a portable electronic apparatus.

A portable electronic apparatus according to the present invention includes: a storing section that stores a pair of designated time and designated position; a time obtaining section that obtains a current time; a position obtaining section that obtains a current position; a determination section that determines whether there is a match or a mismatch between the current position at the current time reaching the designated time and the designated position that is paired with the designated time; and a mismatch processing section that performs mismatch processing in response to a mismatch determined by the determination section as a determination result.

In the portable electronic apparatus according to the present invention, if there is a mismatch between the current position at the designated time and the designated position at the designated time, the processing for mismatch is performed. According to this processing, safety can be improved when the portable electronic apparatus is left behind.

In this portable electronic apparatus, the mismatch processing section may lock the portable electronic apparatus to disable at least a part of the function of the portable electronic apparatus.

The portable electronic apparatus according to the present invention may further include a wireless communication section that wirelessly communicates with external equipment, the storing section may store an address of other equipment to be communicated with in addition to the pair of designated time and designated position, and the mismatch processing section may send a predetermined message to the address of other equipment to be communicated with. In this case, the wireless communication section may be capable of sending an electronic mail, the address of other equipment to be communicated with stored in the storing section may be an electronic mail destination address, and the mismatch processing section may send a predetermined message to the destination address by electronic mail.

In this portable electronic apparatus, the address of other equipment to be communicated with or the destination address may be stored in association with or independently of the pair of designation time and designation position. In addition, the address of other equipment to be communicated with or the destination address may be more than one so that a message can be sent to two or more addresses if a mismatch occurs.

A non-carry processing program storage medium according to the present invention stores a non-carry processing program that is executed in a portable electronic apparatus capable of executing a program, wherein the program provides the apparatus with a non-carry processing function including: a storing section that stores a pair of designated time and designated position; a time obtaining section that obtains a current time; a position obtaining section that obtains a current position; a determination section that determines whether there is a match or a mismatch between the current position at the current time reaching the designated time and the designated position that is paired with the designated time; and a mismatch processing section that performs mismatch processing in response to a mismatch determined by the determination section as a determination result.

According to the present invention, even when a user is not aware that his/her portable electronic apparatus is left behind, safety of such a left behind apparatus can be improved by performing mismatch processing upon detecting a positional mismatch, for example, by locking the apparatus and sending a message to a designated address to warn the user about such a mismatch.

### BRIEF DESCRIPTION OF THE DRAWINGS

FIG. 1 illustrates an example of a communication system including a portable telephone that is a type of portable electronic apparatus according to the present invention;

FIG. 2 is a perspective diagram showing the appearance of the portable telephone;

FIG. 3 is a block diagram illustrating the internal structure of the portable telephone whose appearance is shown in FIG. 2;

FIG. 4 is a block diagram illustrating functions necessary to achieve a feature unique to the present embodiment;

FIG. 5 is a flowchart that shows an operation for registering functions to be used in a non-carry processing mode; and

FIG. 6 is a flowchart that shows an operation for detecting a position and matching in the non-carry processing mode.

### DETAILED DESCRIPTION OF THE INVENTION

An embodiment of the present invention will be described.

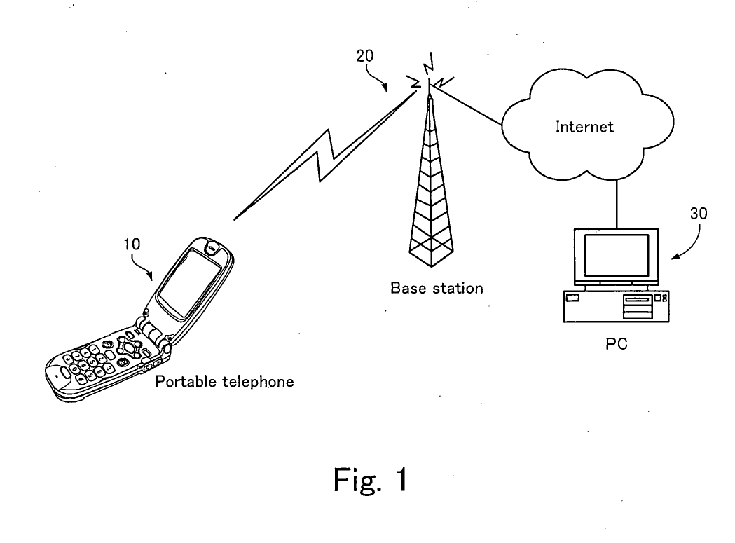

FIG. 1 illustrates an example of a communication system including a portable telephone that is a type of portable electronic apparatus according to the present invention.

FIG. 1 shows a portable telephone 10, a base station 20 that wirelessly communicates with the portable telephone 10, and a personal computer 30 (hereinafter referred to as a PC 30) that is connected to the base station 20 via the Internet. The portable telephone 10 and the PC 30 have the function of exchanging electronic mails. In this example, the portable telephone 10 is usually carried by a user who also uses the PC 30, and the user is scheduled to stay near the PC 30 at least for a certain period of time.

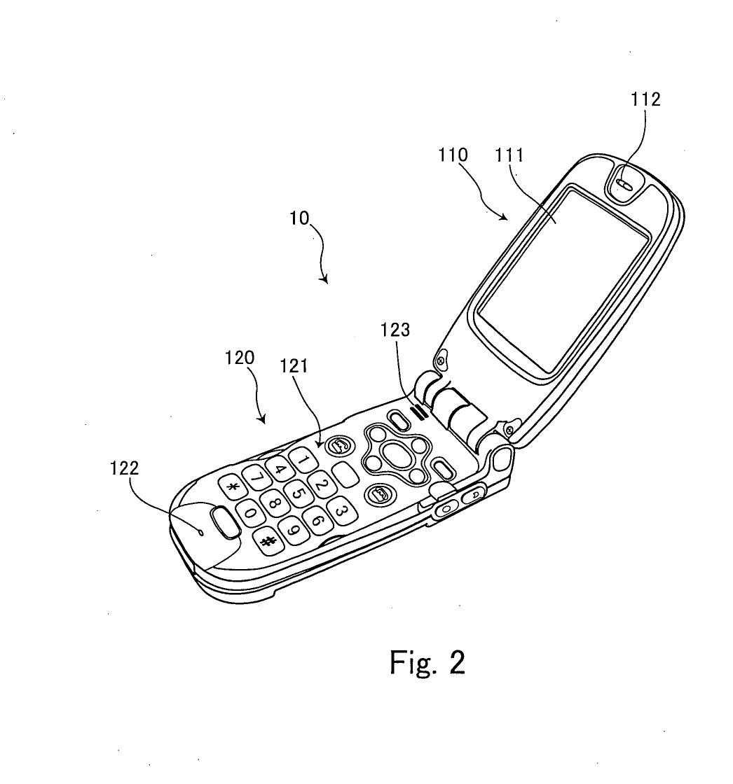

FIG. 2 is a perspective diagram showing the appearance of the portable telephone.

The portable telephone 10 is composed of an upper enclosure 110 and a lower enclosure 120 which can be opened and closed with respect to each other. The upper enclosure 110 includes a LCD 111 for displaying various images and an earpiece 112 provided with a small speaker out of which sounds come when it is put to the user's ear. The lower enclosure 120 includes: various keys 121 used for entering telephone numbers and e-mail messages and for setting various modes; a mouthpiece 122 provided with a microphone for picking up the user's voice when it is brought close to the user's mouth; and a loudspeaker-sound opening 123 provided with a large loudspeaker for allowing the user to hear other party's voice even when the portable telephone 10 is not near the user's face. The portable telephone 10 has the function of sending/receiving messages by telephone as well as by e-mail through wireless communications.

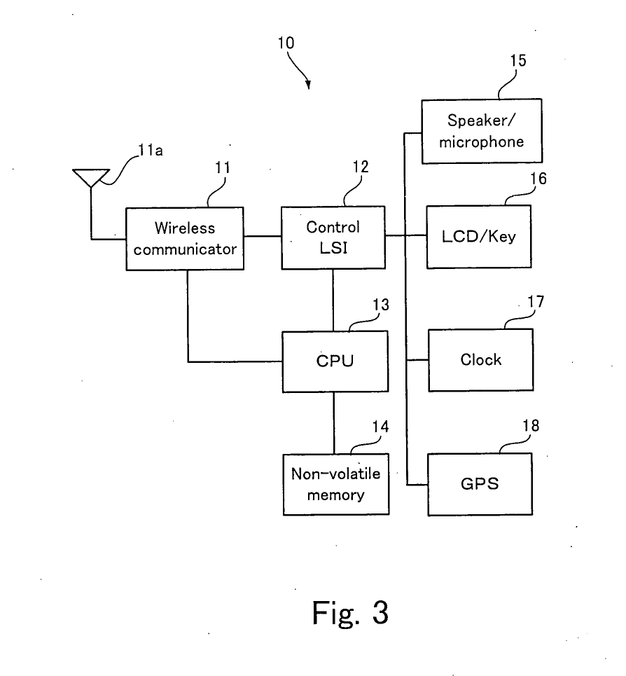

FIG. 3 is a block diagram illustrating the internal structure of the portable telephone 10 whose appearance is shown in FIG. 2.

FIG. 3 shows a wireless communicator 11, a control LSI 12, a CPU 13, a non-volatile memory 14, a speaker/microphone 15, a LCD/key 16, a clock 17, and a Global Positioning System (GPS) 18.

The wireless communicator 11 wirelessly communicates with external equipment etc. via an antenna 11a. The control LSI 12 is adapted to intermediate and process, under the control of the CPU 13, signals between the wireless communicator 11 and the speaker/microphone 15; between the wireless communicator 11 and the LCD/key 16; and between the CPU 13 and the speaker/microphone 15, LCD/key 16, clock 17, and GPS 18.

The CPU 13 executes programs to control the wireless communicator 11 and the control LSI 12, and obtains information from the LCD/key 16, clock 17, and GPS 18 via the control LSI 12.

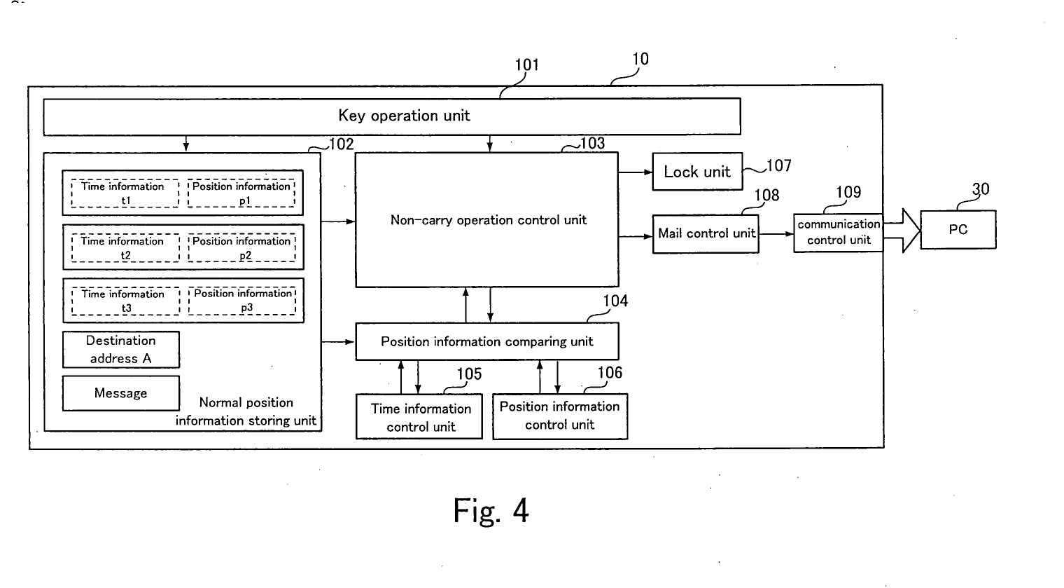

The non-volatile memory 14 stores programs to be executed in the CPU 13 and various kinds of information that will be described later with reference to FIG. 4.

The speaker/microphone 15 is used when the portable telephone 10 is functioning mainly as a telephone and serves to deliver messages to the user and to pick up the user's voice.

The LCD/key 16 corresponds to the LCD 111 and various keys 121 in the appearance shown in FIG. 2 and serves to display images and to detect key operations performed by the user.

The clock 17 reports the current time, and the GPS 18 detects and reports the current position of the portable telephone 10.

FIG. 4 is a block diagram illustrating functions necessary to achieve a feature unique to the present embodiment (non-carry processing mode), which consists of a combination of the hardware of the portable telephone 10 and the software programs executed in the CPU 13 of the portable telephone 10.

FIG. 4 shows a key operation unit 101. The key operation unit 101 is comprised of the various keys 121 shown in FIG. 2 and a detection switch (not shown) for detecting operations provided through the keys 121. Normally, information that is input through the key operation unit 101 by a key operation in the non-carry processing mode is stored in a normal position information storing unit 102. The normal position information storing unit 102 is configured within the non-volatile memory 14 shown in FIG. 3, and stores time information and position information in a pair as well as stores an e-mail address as a destination address.

As shown in FIG. 4, there are stored through the user's key operations: time information t1 and position information p1 in a pair; time information t2 and position information p2 in a pair; time information t3 and position information p3 in a pair; a destination address A that is an e-mail address used by the PC 30; and a message to be sent to the destination address.

In this figure, although only the address A is stored as a destination address, two or more destination addresses may be stored and the destination addresses may be associated with pairs of time information and position information. In addition, instead of entering a message through a key operation by a user, predetermined messages may be stored beforehand.

A pair of time information and position information stored in the normal position information storing unit 102 is such that at the time represented by the time information, normally, the user is scheduled to be at the position represented by the position information that is paired with the time information. Therefore, the portable telephone 10 should naturally be at the position as well when the user carries it.

FIG. 4 also shows a non-carry operation control unit 103 that receives an instruction from the user as to ON/OFF of the non-carry operation mode through the key operation unit 101. When the non-carry operation mode is made ON by an instruction, the non-carry operation control unit 103 orders a position information comparing unit 104 to carry out a position information comparing processing.

A time information control unit 105 shown in FIG. 4 corresponds to the clock 17 shown in FIG. 3 in terms of hardware, and informs the position information comparing unit 104 of the current time in response to a request from the position information comparing unit 104.

A position information control unit 106 shown in FIG. 4 corresponds to the GPS 18 shown in FIG. 3 in terms of hardware, and informs the position information comparing unit 104 of the current position in response to a request from the position information comparing unit 104.

The position information comparing unit 104 periodically receives the current time from the time information control unit 105, and refers to the time information t1, t2, t3 that are paired with the respective pieces of position information and stored in the normal position information storing unit 102, so as to determine whether the current time matches the time represented by any one of the time information t1, t2, t3 stored in the normal position information storing unit 102. If the current time matches the time represented by one of t1, t2, and t3 (assume it matches the time represented by the time information t1 in this case), the position information comparing unit 104 receives the position information about the current position from the position information control unit 106 and determines whether or not the current position matches the position represented by the position information p1 that is paired with the time information t1 whose time matches the current time and stored in the unit 102. If the result of this matching is within a predetermined positional error range, it is determined there is a match, whereas if the result is out of the range, it is determined there is a mismatch. The result of the matching is then supplied to the non-carry operation control unit 103.

If it is determined by the position information comparing unit 104 that there is a mismatch as a result of such a positional matching, the non-carry operation control unit 103 receives therefrom such a result. The non-carry operation control unit 103 then reads out the destination address A and the message from the normal position information storing unit 102, and sends them to a mail control unit 108 together with an instruction to send the message to the destination address A by e-mail. The mail control unit 108 prepares an e-mail according to the instruction to pass it to a communication control unit 109 and gives an instruction to the communication control unit 109 to send the e-mail. In response to this instruction, the communication control unit 109 sends the e-mail received from the mail control unit 108 to the PC 30 of the user who uses the destination address A as an e-mail address.

Besides giving an instruction to send the message to the destination address A as described above, upon receipt of such a matching result that there is a positional mismatch from the position information comparing unit 104, the non-carry operation control unit 103 gives an instruction to a lock unit 107 to lock the portable telephone 10. In response to this instruction, the lock unit 107 locks the portable telephone 10 to disable the function of the portable telephone 10.

The operations of the non-carry operation control unit 103, position information comparing unit 104, lock unit 107, and mail control unit 108 shown in FIG. 4 are mainly performed by the CPU 13 shown in FIG. 3 in terms of hardware and partially performed by the control LSI 12. The operation of the communication control unit 109 is mainly performed by the wireless communicator 11 and the antenna 11a in terms of hardware.

As described above, according to the present embodiment, if there is a mismatch between the position represented by the stored position information and the current position, the PC 30 of the user is informed of such a mismatch and at the same time the portable telephone 10 is locked so that its function is disabled. This improves safety against fraudulent use of the portable telephone 10.

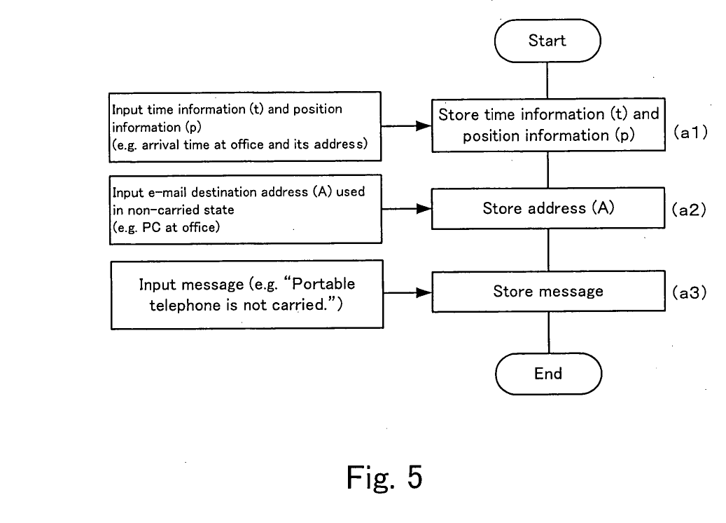

FIG. 5 is a flowchart that shows an operation for registering functions to be used in the non-carry processing mode.

Upon input of time information (t) and position information (p) (for example, a time of arrival at an office and its address) by the user through a key operation, the input information is stored in the normal position information storing unit 102 shown in FIG. 4 (non-volatile memory 14 shown in FIG. 3) at step (a1). Further, upon input of a destination address (A), which is to be used when it is determined that the telephone is in a non-carried state, by the user through a key operation, the input address is also stored in the normal position information storing unit 102 shown in FIG. 4 at step (a2). Furthermore, upon input of a message, that is to be sent when it is determined that the telephone is in a non-carried state, by the user through a key operation, the input message is also stored in the normal position information storing unit 102 shown in FIG. 4 at step (a3).

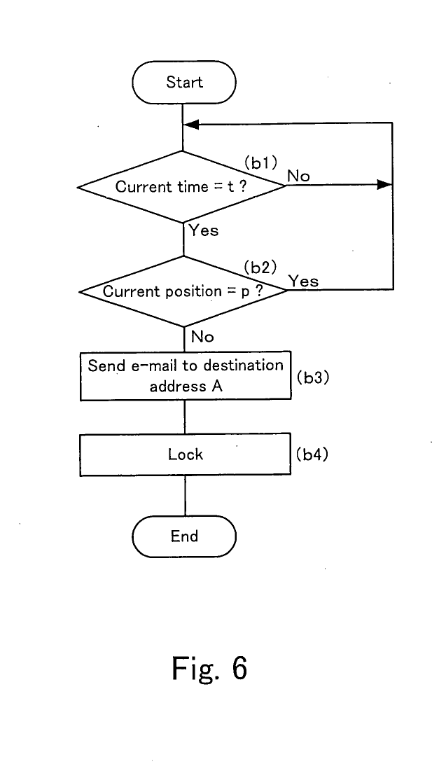

FIG. 6 is a flowchart that shows an operation for detecting a position and matching in the non-carry processing mode.

At step (b1), it is periodically determined whether the current time matches the time represented by any one of the time information t1, t2, and t3 (represented by (t) in FIG. 6) that are paired with the position information p1, p2, and p3 (represented by (p) in FIG. 6), respectively and stored in the normal position information storing unit 102. If there is a match between the current time and the time represented by any one of the time information t1, t2, and t3, subsequently at step (b2), it is determined whether the current position matches the position represented by the stored position information p (position information p1 in this case) that is paired with the time information (time information t1 in this case) that represents the time matching the current time. If there is a match between the current position and the stored position, the periodical time matching continues thereafter without initiating any specific action.

If there is a mismatch between the current position and the stored position, the message is sent to the destination address (A) by e-mail at step (b3). Subsequently, the portable telephone 10 is locked at step (b4) so that it is disabled.

Steps (b1) and (b2) in this figure correspond to the position information comparing unit 104 shown in FIG. 4, step (b3) corresponds to a combination of the mail control unit 108 and the communication control unit 109 shown in FIG. 4, and step (b4) corresponds to the lock unit 107 shown in FIG. 4.

In the above embodiment, there has been described a case where a message is sent from the portable telephone 10 by e-mail as well as the portable telephone 10 is locked. However, even if only one of these is carried out, safety against fraudulent use can be improved.

Further, a message from the portable telephone 10 is not necessarily sent by e-mail. For example, a voice message may be sent to a destination represented by a telephone number that is stored beforehand as a destination address.

Furthermore, although the use of the portable telephone 10 has been described as an example in the above-embodiment, the present invention should not be limited to the portable telephone 10. The present invention can be applied to various kinds of devices such as PDAs only having the function of communicating by e-mail without having the function of communicating by telephone and other kinds of portable electronic devices.

What is claimed is:

1. A portable electronic apparatus comprising:
a storing section that stores a pair of designated time and designated position;
a time obtaining section that obtains a current time;
a position obtaining section that obtains a current position;
a determination section that determines whether there is a match or a mismatch between the current position at the current time reaching the designated time and the designated position that is paired with the designated time; and
a mismatch processing section that performs mismatch processing in response to a mismatch determined by the determination section as a determination result.

2. A portable electronic apparatus according to claim 1, wherein the mismatch processing section locks the portable electronic apparatus to disable at least a part of the function of the portable electronic apparatus.

3. A portable electronic apparatus according to claim 1, further comprising:
a wireless communication section that wirelessly communicates with external equipment,
wherein the storing section stores an address of other equipment to be communicated with in addition to the pair of designated time and designated position, and
wherein the mismatch processing section sends a predetermined message to the address of other equipment to be communicated with.

4. A portable electronic apparatus according to claim 3, wherein the wireless communication section is capable of sending an electronic mail and the address of other equipment to be communicated with stored in the storing section is an electronic mail destination address, and
wherein the mismatch processing section sends a predetermined message to the destination address by electronic mail.

5. A non-carry processing program storage medium which stores a non-carry processing program that is executed in a portable electronic apparatus capable of executing a program, wherein:
the program provides the apparatus with a non-carry processing function comprising:
a storing section that stores a pair of designated time and designated position;
a time obtaining section that obtains a current time;
a position obtaining section that obtains a current position;
a determination section that determines whether there is a match or a mismatch between the current position at the current time reaching the designated time and the designated position that is paired with the designated time; and
a mismatch processing section that performs mismatch processing in response to a mismatch determined by the determination section as a determination result.
